(19) United States
(12) Patent Application Publication
(10) Pub. No.: US 2009/0033149 A1
(43) Pub. Date: Feb. 5, 2009

(54) USB power port in a vehicle dashboard

(76) Inventor: Bharat Patel, Boynton Beach, FL (US)

Correspondence Address: OSHA LIANG L.L.P., TWO HOUSTON CENTER, 909 FANNIN, SUITE 3500, HOUSTON, TX, 77010, US

(21) Appl. No.: 11/888,728

(22) Filed: Aug. 2, 2007

(51) Int. Cl. B60L 1/00; H02J 7/00

(52) U.S. Cl. 307/10.1; 320/114

(57) ABSTRACT

A vehicle dashboard mounted USB port connected to the vehicle electrical power through a voltage conversion circuit for receiving standard vehicle operating voltage and converting it into standard USB voltage.

### BACKGROUND OF INVENTION

Portable electronic devices have become more and more popular in recent years. For example, portable radios, portable music recording a music playing devices, portable cellular telephones, portable hand held personal data assistants (PDAs) and portable handheld and laptop computers are very popular. Portable electronic devices are typically powered with batteries when used in a portable mode or a plug-in power supply when used in a stationary mode. Many such devices are provided with optional rechargeable batteries or with permanently installed rechargeable batteries. In such cases a plug-in power supply device may either provide operating electrical power or electrical power for recharging the rechargeable batteries or both. The voltage used by any particular portable electronic device (sometimes referred to herein as a PED) is not always the same for different PEDs. Traditionally, many PEDs are made to operate on voltages selected in increments of 1.5 volts (such as 1.5, 3, 4.5, 6, 7.5, and 9 volts for example) chosen by a manufacturer for their particular PED. This allows the use of alkaline replacement batteries that may be inserted into the PED in a series arrangement of multiple alkaline batteries of 1.5 volts. Rechargeable batteries, as for example NiCad batteries that also have a nominal full charge voltage of about 1.5 volts may also be provided in increments of to match the number of replaceable alkaline batteries that might be required. Rechargeable NiCad batteries could often be used in place of the standard alkaline replacement batteries to provide convenient rechargeable capabilities in place of the replaceable batteries.

In many instances a manufacture of a PED would also provide a separate power supply or recharging devices together with the PED. After market power supply/recharging devices have also been available in the market place. Such recharging devices were used to convert standard electrical power (current at a given voltage) into a required charging current and voltage for the particular PED to operate or for the appropriate battery or batteries to be charged. For example, a PED may operate on 7.5 volts DC and the expected available source power or a standard input power to the recharging device might be a standard US household voltage of 110-120 volts alternating current (VAC). For example, 110 VAC to 120 VAC is usually available in most US homes, hotels, and buildings at wall sockets to are typically capable of providing at least up to about 10 amps of current and typically a maximum of up to about 60 amps of current, depending upon the building wiring and fuses or circuit breakers. Another example of a standard available power is a standard automotive voltage of 12 volts direct current (VDC), usually provided by a large capacity lead acid battery that is carried onboard most automobiles, trucks and other vehicles and that is kept charged during running of the vehicle or recharged by an alternator. Usually automobiles have wires and circuits with a capability of carrying up to at least about 5 amps and a maximum of up to about 50 amps depending upon the automobile wiring and fuses.

The type of charging device circuitry is different for the household Alternating Current (AC) and for the automotive Direct Current (DC). The operating power supply or the re-charging devices convert the input electrical voltage and current into an appropriate operating or charging voltage and current. The voltage and current that is appropriate depends upon the requirements of the PED and the design and number of rechargeable batteries for which the recharging device is designed. Such recharging devices are typically provided with either a household plug for receiving household electrical power or an automotive electrical receptacle generally known as a cigarette lighter plug. For many years almost all automobiles have been provided with a dashboard mounted plug-in cigarette lighter that conveniently provides access to an automotive electrical circuit connected to a 12 VDC battery, generator, and/or the alternator of the automobile.

Thus, the user of rechargeable PEDs typically has an option of purchasing one type of re-charger for use with household electrical power in a building or another type for use with automotive electrical power in a vehicle. A traveler may have one charger for use while driving and another for use when in a home, hotel, or building at a destination. It will be noted that different voltage and current conversion circuitry is required, even for the same PED, depending upon whether the power source will be household AC or automotive DC. Thus, two recharging devices were often carried by travelers to accommodate both or either in-building operation/recharging and car operation/recharging as might be available at a time that the charge of the batteries of the PED became insufficient for proper operation.

In more recent years, many different types and voltages of batteries have been developed and adopted by manufactures. For example, nickel metal hydride (NiMetal Hydride) cells have a nominal voltage of 1.2 volts, although at full high charge they may be as high as 1.5 volts. NiMetal Hydride cells can generally provide a direct replacement for alkaline batteries in many applications. Other examples include lithium ion (Li+) batteries that typically are chargeable to about 4.1 to 4.2 volts for single cells and lithium polymer (Li-Poly) batteries typically are chargeable to about the 4.3 to 4.4 volts range. In many modern portable electronic devices these types of rechargeable batteries are often built right into the portable electronic devices or attached as a specially shaped cell to be part of the PED. Such PEDs are typically provide with a separate recharging unit having appropriate recharging circuitry and connectable to the portable electronic device with a special plug and cord adapter. The type of circuitry and plug for a particular recharging unit will differ depending upon the intended source of power, 115 VAC, 12 VDC or another voltage and current that may be “standard” in other countries outside of the US. In many instance a recharging circuit may be built into the PED and only an adapter cord with the required plug connections might be separately provided to connect the PED to a standard power source. The adapter cord still needs to match the intended power source and often travelers purchase both types (AC plug and DC car charger plug) so that charging is available with either a household current outlet or an automobile cigarette lighter receptacle. Such adapter cords or plug-in charging units typically connect to the PED with a plug and receptacle that is unique or proprietary to the particular PED or the particular manufacturer. As used here the term “unique” as applied to the connector may mean that the manufacturer has selected one of many available plug and receptacle configurations selected or produced by the manufacturer. It is unique because there is no true adopted standard for all PEDs.

Thus, one end of the connector or cord plugs into the PED and the other end of the connector or cord is be adapted to one or the other of a household plug or a cigarette lighter plug. It continues to be appropriate for a traveler to carry two recharging units or two cords to be able to accommodate either automobile operation/recharging or in-building operation/recharging.

Certain advances in computer technology have led to the development of a connector known as a universal serial bus (USB). A USB connector is often called a USB port and it includes a generally rectangular shaped male and female plug-in connection with a number of slide together contact electrical connection terminals. The terminals are arranged in a standardized pattern and when connected provide for rapid data transfer and information communication between computers, PEDs, and data storage devices, such as for example between two computers, between a computer and a PED, or between a computer and a data storage device. To facilitate the use of inexpensive data storage devices and other peripheral devices, the USB ports also include electrical power terminals in addition to the data connection terminals. Currently, most USB ports provide electrical power from an electrical device such as a computer in which the USB port is mounted. The electrical power available for transmission with a USB port is currently standardized at 5 volts DC for available USB protocol devices whether USB 1.1 or USB 2.0. The electrical power is provided at 5 volts DC and 100 ramps, for a low power USB port, and up to 500 Ramps for a high power USB port. Some USB operating circuitry allows for a peripheral device to specify (with an appropriate data signal) the amount of current required in increments of 100 μamps, up to a total of 500 μamps.

Some portable electrical devices and some operating/recharging units, such as those with recharging circuits for NiCad batteries, circuits for nickel metal hydride batteries, circuits for lithium ion batteries, or circuits for lithium polymer batteries, have now been adapted to connect to USB ports. Such operating power/battery recharging units convert the available 5 VDC into an appropriate recharging voltage and current for the particular PED. A wide variety of recharging devices and cords are available from various portable electronic device manufactures and also from after market providers of recharging units. In the case of PEDs that are designed with onboard charging circuitry and that use USB voltage and current, a USB cable may be required to make a connection to a powered USB port that can typically be found on most modern personal computers.

Travelers often have other portable devices such as personal computers that plug into standard household receptacles and include built in USB ports so that a USB charging cord may be used to power or recharge a PED when the traveler is in a hotel room, office or housed where the PC may be plugged in. The same USB charging cord does not work in the present cigarette lighter receptacles in vehicles without additional plug-in conversion devices. This can often lead to the carrying of additional cords/recharging devices to accommodate the traveler's has portable electronic devices with household electrical power sources and with vehicle or automotive electrical power sources.

Travelers with any of a variety of available portable electronic devices often no longer have the option to carry spare replacement alkaline batteries, but instead travel with the recharging cords or recharging devices specially adapted for each of the portable electrical devices being carried by the traveler. This can often lead to the carrying of two times as many cords/recharging devices as the traveler has portable electronic devices.

### SUMMARY OF INVENTION

In general, in one or more aspects, the invention relates to a vehicle dashboard mounted USB port connected to the vehicle electrical power through a voltage conversion circuit for receiving standard vehicle operating voltage and converting it into standard USB voltage.

In one or more embodiments, the dashboard mounted USB power port includes a female receptacle with electrical power transmission contacts in standard USB locations for removable engagement with a USB plug having at least the corresponding power transmission contact terminals, wherein the plug is removeably connectable to a standard USB powered device or a recharging unit for a portable electrical device (PED).

In one or more embodiments a threaded receptacle is affixed in the vehicle dashboard configured for receiving a correspondingly threaded upgradeable USB power port adapter.

Other aspects and alternative useful embodiments of the invention will be apparent from the following description and the appended claims.

### BRIEF DESCRIPTION OF DRAWINGS

FIG. 1 shows a prior art vehicle dashboard with a cigarette lighter in a receptacle

FIG. 2 is a perspective view of a portion of the prior art dashboard of FIG. 1.

FIG. 3 is a perspective view of a vehicle dashboard with a USB power port mounted therein according to one or more embodiments of the invention.

FIG. 4 is a schematic view of a DC to DC conversion circuit for a dashboard mounted USB power port in accordance with one or more embodiments of the invention.

FIG. 5 is a schematic cut-away side view a vehicle driver compartment and dashboard with a USB power port securely mounted there therein and connected to a vehicle electrical power supply according to one or more embodiments of the invention.

FIG. 6 is a perspective view of a vehicle dashboard with a plural USB power port securely mounted there therein according to one or more embodiments of the invention.

FIG. 7 is a perspective view of a vehicle dashboard with a threaded receptacle for attachment of an upgradeable dashboard mounted USB power port in accordance with one or more embodiments of the invention.

FIG. 8 is a perspective view of an upgradeable threaded USB adaptor with a USB power port for securely mounting in a vehicle dashboard in accordance with one or more embodiments of the invention.

FIG. 9 is a front view of a threaded receptacle for mounting in a vehicle dashboard to receive a USB converter with a single power port securely mounted to a vehicle dashboard.

FIG. 10 is a perspective view of a USB adaptor cord for connecting to a rechargeable PED via a USB power port securely mounted to a vehicle dashboard.

FIG. 11 is a perspective view of a vehicle dashboard with a plurality of USB power ports with different size configurations securely mounted there therein according to one or more alternative embodiments of the invention.

FIG. 12 is a perspective view of a vehicle dashboard with a plurality of USB power ports securely mounted therein and having moveable covers according to one or more alternative embodiments of the invention.

### DETAILED DESCRIPTION

One or more embodiments of the invention will be described with reference to the accompanying figures. Like items in the figures are shown with the same reference numbers.

In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

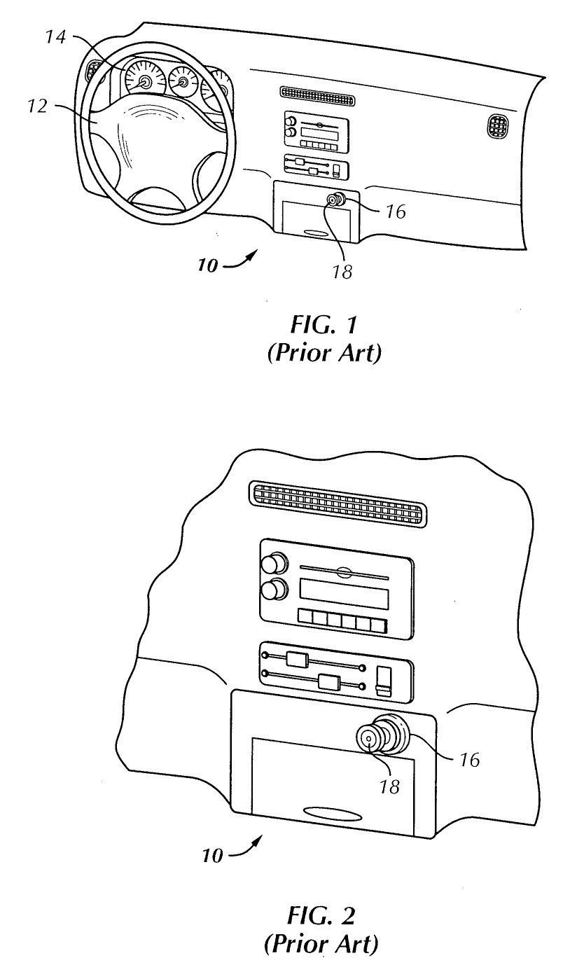

FIG. 1 shows a prior art dashboard 10 of a vehicle with a cigarette lighter in a vehicle power receptacle. The dashboard 10 is supported from a vehicle (not shown), typically ahead of the vehicle operator in a forward motion direction. An operator of the vehicle and in some cases passengers will typically ride in a cab or other operator compartment with the dashboard in front of them. A steering wheel 12 and instruments 14 allow the operator to drive or otherwise control the vehicle while it is in motion. Power from the vehicle power system, such as a battery, a generator or an alternator, is typically accessible from the dashboard through a cigarette lighter receptacle 16. In this depiction a cigarette lighter 18 is inserted into the receptacle 16.

FIG. 2 shows a close-up portion of the dashboard 10 of FIG. 1 with the cigarette lighter receptacle 16 and the cigarette lighter 18 therein.

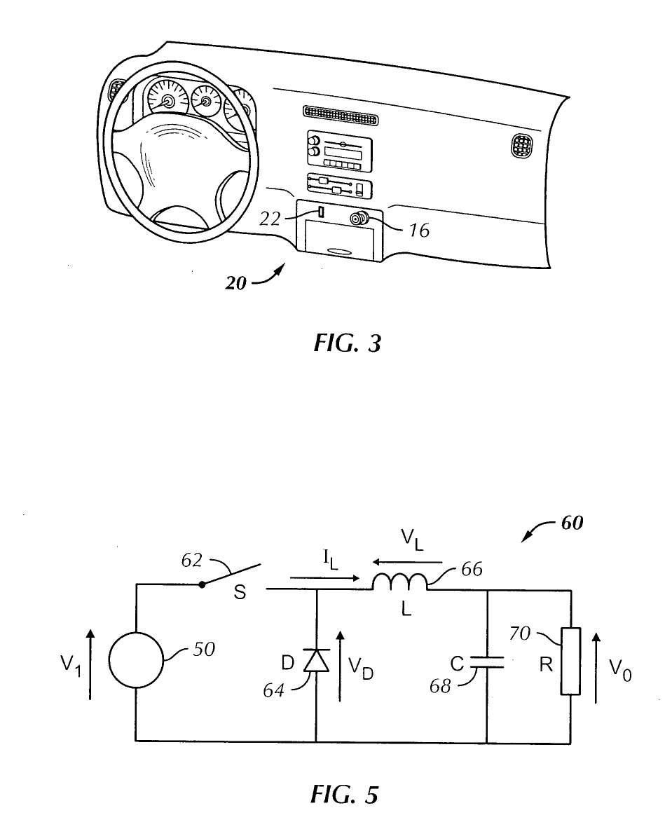

FIG. 3 shows a vehicle dashboard 20 with a USB power port 22 mounted there therein according to one or more embodiments of the invention. It will be understood based upon the present disclosure that the use of the term “USB power port” herein refers to a receptacle that has a standard USB size and shape and electrical power contacts or electrical connection in established standard positions for a USB data port. The standard electrical power connections are supplied with standard USB electrical voltage and current capabilities as established for standard USB ports. The connection terminals in a standard USB port that are designated for data transmission need not be connected for establishing such data transfer. In one or more embodiments certain data transmission terminals that are designated for communication PED charging control information may be connected.

In an embodiment shown in FIG. 3, the USB power port is securely mounted adjacent to the driver operated vehicle controls such as the steering wheel 12 and instruments 14. This usefully provides the operator of the vehicle with convenient access to the USB power port 22. The USB power port may also be mounted adjacent to a standard cigarette lighter receptacle 16.

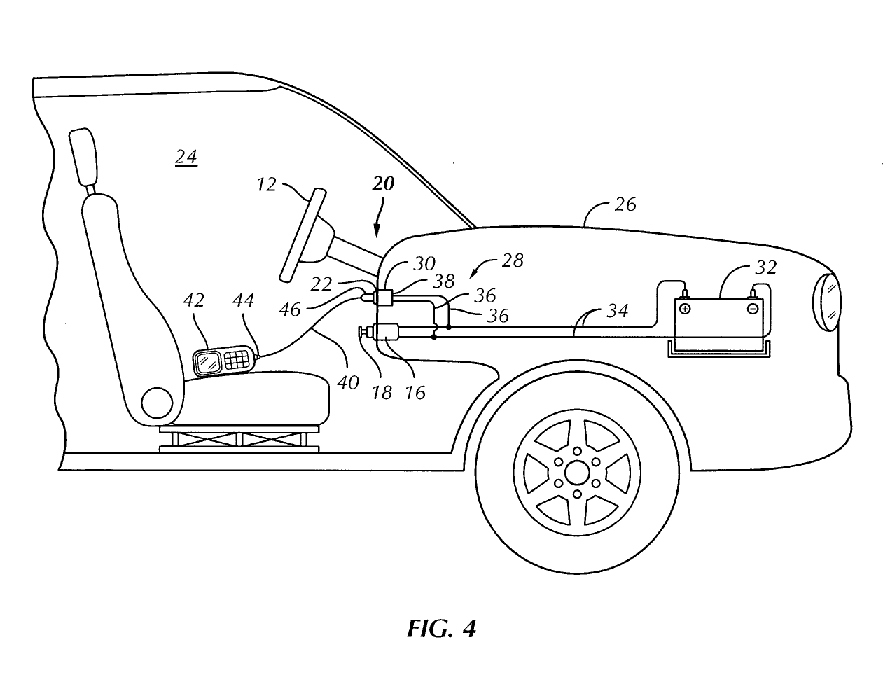

FIG. 4 is shows a vehicle 26 with a driver or operator compartment 24 and dashboard 20 with a USB power port 22 securely mounted therein. A power circuit 28 connects the USB power transmission contacts 30 to the vehicle power source 32, such as a battery 32. In the embodiment shown wires 34 are connected to the power port 22 through connectors 36 and a voltage conversion circuit 38. For example where the standard vehicle operating voltage is nominally 12 VDC, and the standard USB voltage is nominally 5 VDC, the conversion circuit 38 converts the voltage from the vehicle power source from 12 VDC to 5 VDC. It will be understood that the range of voltage in a nominal 12 VDC vehicle system could for example range from about 11 VDC to about 13 VDC or an even a wider range. The conversion may be in a range of about 4.5 to about 5.5 VDC or a more sophisticated circuit may also monitor and control the output voltage more closely to the nominal 5 VDC and within the tolerances as may be established for USB standards. In some situations the same wires 34 might also provide power to the cigarette lighter 18 through receptacle 16 as shown and in other cases a separate circuit may connect the power source 32 of the vehicle. It may also be understood that although the power source 32 is depicted as a battery and a nominal voltage of 12 VDC is given as an example, the vehicle power source might also be a generator or an alternator and/or the nominal voltage might be 6 VDC, as for example motorcycle or a boat, or 18 VDC, as for example for an airplane, or other vehicular voltages and currents as may be used to power vehicles.

Also depicted in FIG. 4 to demonstrate one possible use of the invention is a USB to PED adaptor cable 40. The adaptor cable 40 is connecting between a PED 42 with the appropriate connector 44 and to the USB power port 22 with a standard USB plug 46. It will be noted that for most applications the data terminals of the USB plug need not communicate to any computer system of the vehicle 26 in order to receive power from the USB power port 22.

FIG. 5 shows a schematic view of a DC to DC conversion circuit 60 that, for example, may be in the form of a switch mode power supply (SMPS) as depicted. For purposes of illustration and with the expectation that normally the input vehicle voltage will be a standard DC automotive voltage of about 12 volts, or a rectified voltage as from a generator, alternator, or other rectification circuit (not shown) a step down converter circuit 60 is shown that is also known as a buck converter, because it “bucks” or reduces the voltage. Although one example circuit 60 is shown, it will be understood by those of ordinary skill in the art based upon this disclosure that other types of SMPS converters or alternatively linear converters might be used without departing from aspects of various embodiments of the invention. In the conversion circuit 60 depicted, Vi is an input DC voltage as might be provided by the vehicle power source 32 (see FIG. 4) or from a generator, alternator or a rectifier circuit. An electronic switch (S), at 62, cycles on and off at a predetermined frequency. Thus, the switch 62 alternates between connecting the remainder of the circuit to the input voltage Vi and disconnecting the voltage to the circuit. By use of a diode (D) at 64, and an inductor (L), at 66, and alternately connecting the source voltage to this part of the circuit, energy is stored in the inductor 66 and capacitor 68. When the circuit is disconnected from the voltage the stored energy is discharged as electrical current from the inductor and capacitor into the load that is represented by a capacitance (C), at 68, and a resistance (R), at 70. The energy storage of the inductor, and thus the output voltage Vo, may be determined by selection of the components. The output voltage Vo provided to the USB power port 22 (see FIG. 4) can be regulated to a fixed voltage during varying current demands by adjusting the on/off duty cycle. Self regulating SMPS circuits are available.

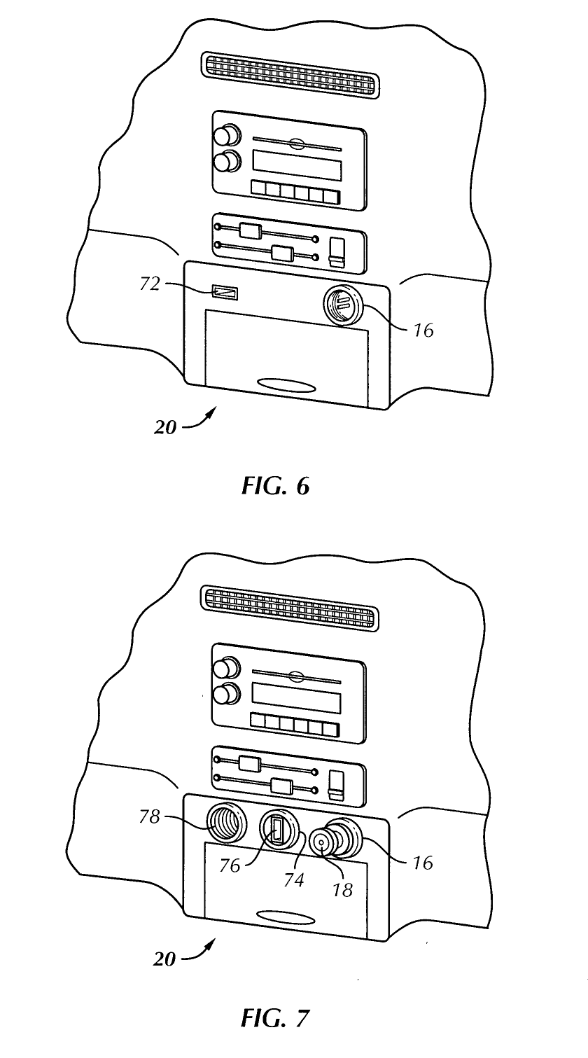

FIG. 6 shows a vehicle dashboard with plural USB power port receptacles 72 securely mounted there therein according to one or more embodiments of the invention. A cigarette lighter receptacle 16 with the cigarette lighter removed is also shown.

FIG. 7 shows a vehicle dashboard with a threaded receptacle 74 for attachment of an upgradeable dashboard mounted USB power port 76 in accordance with one or more embodiments of the invention. Another threaded receptacle 78 is also depicted to demonstrate an embodiment by which another USB power port (not shown) similar to the USB power port 76 may be securely mounted into the vehicle dashboard 20.

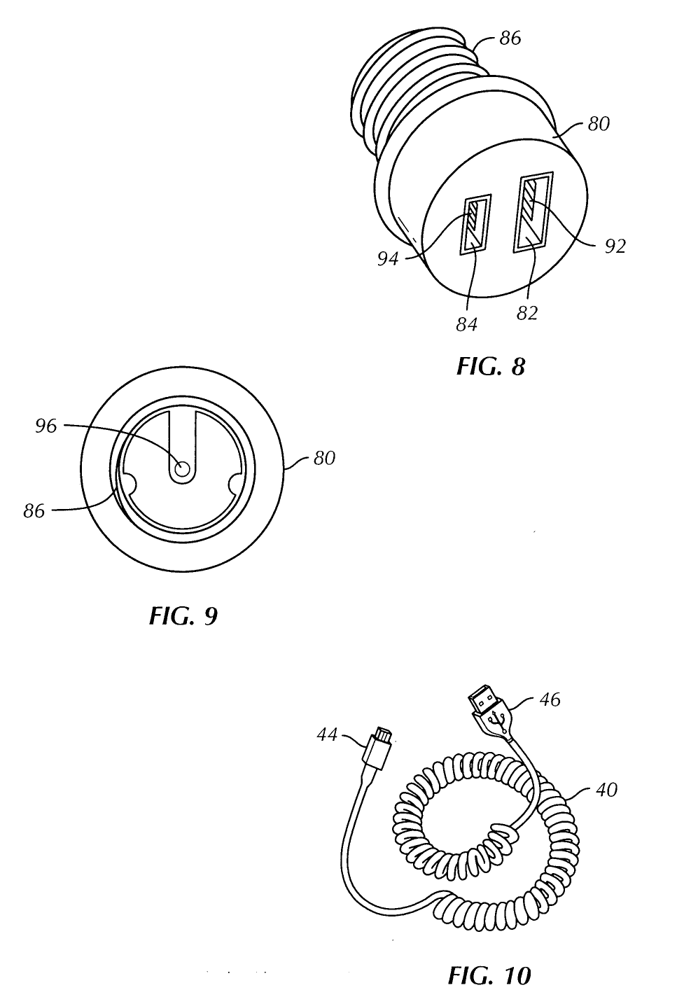

FIG. 8 shows an embodiment of an upgradeable threaded USB adapter 80 with dual power ports 82, for a USB 2.0 version power port, and 84, for a USB 1.1 version power port for securely mounting in a vehicle dashboard. The upgradeable threaded USB adapter 80 includes external threads 86; sized for threaded engagement into internal treads the receptacles 74 and 78 (see FIG. 7). The USB ports 82 and 84 have internal electrical contacts 92 and 94, respectively, corresponding to the electrical power contacts of standard USB port connectors. Under present standards for USB ports, the voltages for either USB version 1.1 or USB version 2.0 are nominally 5 volts DC. There are often changes in the standards for different kinds of technology such as USB ports. Also, thought it is common for vehicles to operate at a nominal voltage of 12 VDC, other voltages could be used in a particular vehicle. The use of a threaded USB adapter 80, according to one or more embodiments of the invention, allows for these possibilities so that the threaded USB receptacle receiving the available vehicle voltage and current can convert to the appropriate USB voltage standard voltage. If the standard vehicle voltage is different or if the standard USB voltage is different, an adapter with a different conversion circuit can be securely threaded into the threaded receptacle to provide the new standard voltage without disassembling or replacing the dashboard.

FIG. 9 shows a back view of an embodiment of the treaded adapter 80 of FIG. 8. The threads 86 may be constructed to contact one pole (plus or minus) of the electrical connecter from the vehicle electrical power source and a terminal contact 92 may be constructed for contacting the other pole (minus or plus). The DC to DC conversion circuit (see FIG. 4) may be contained within the adapter 80.

FIG. 10 shows a USB adaptor cord 40 for connecting to a rechargeable PED by a connecter 44 and to a USB power port securely mounted to a vehicle dashboard by a USB plug 46.

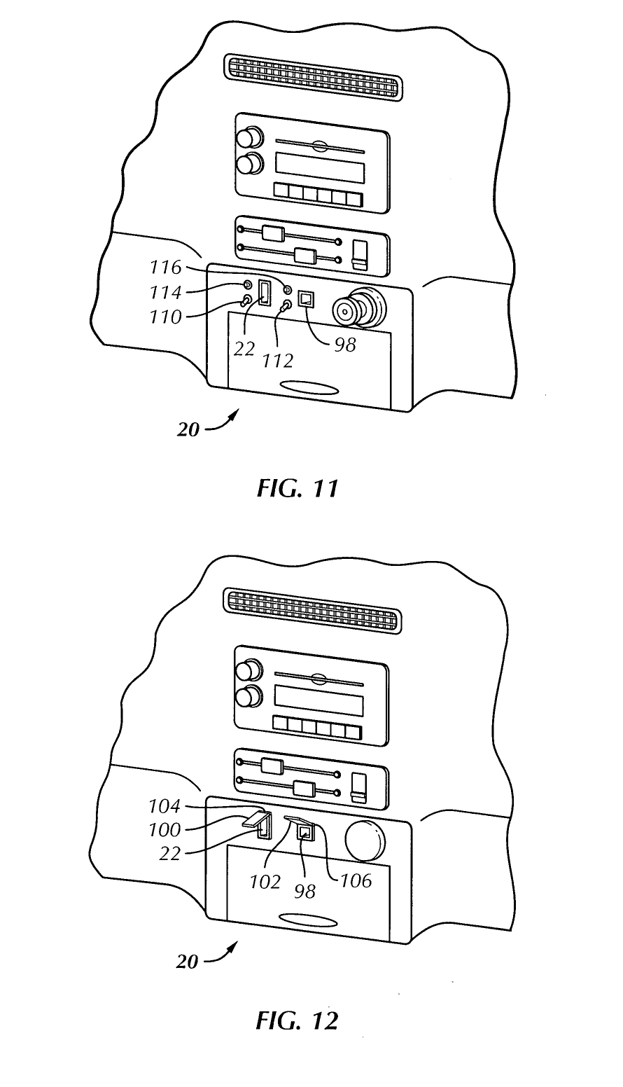

FIG. 11 shows an alternative embodiment of a vehicle dashboard 20 with a plurality of USB power ports 22 and 98 with different size configurations securely mounted into the dashboard 20. In one or more alternative embodiments one or all of the USB ports may be activated with switches 110 and 112. The switch may be connected between the power source and the conversion circuit or between the conversion circuit and the USB port. One or all of the USB ports may be associated with indicator lights 114 and 116 that may be illuminated to indicate when the USB electrical power is available.

FIG. 12 shows another alternative embodiment of a vehicle dashboard 20 with a plurality of USB power ports 22 and 98 securely mounted therein and having moveable covers 100 and 102. The covers provide protection against dust and debris when a plug is not connected. The covers may be completely removable or they may remain attached to the dashboard as with a flexible connector 104 or a hinged connection 104.

While the invention has been described with respect to a limited number of embodiments, those skilled in the art, having benefit of this disclosure, will appreciate that other embodiments can be devised which do not depart from the scope of the invention as disclosed herein. It will also be understood that while various aspects and embodiments are shown in various figures, more than one of the various features may be usefully combined in one or more embodiments within the scope of the invention. Accordingly, the scope of the invention should be limited only by the attached claims.

1. (canceled)

2. A method of operating a cellular telephone, the cellular telephone being operated by a first user and including a display, and being selectively operable in a mode in which a group call is supported among more than two parties according to a push-to-talk-over-cellular (PoC) procedure, the cellular telephone including a designation of a group of cellular telephone users other than the first user, the method comprising:
entering into a group call session in accordance with said PoC procedure, the designated group being selected for the group call session; and
displaying on the display information that indicates how many members of the designated group are in an active status relative to the group call session;
wherein the displaying includes displaying a first numeral that indicates how many members of the designated group are in an active status relative to the group call session, followed in space on the display by a symbol, followed in space on the display by a second numeral that indicates how many members are included in the designated group.

3. A method according to claim 2, wherein said symbol is “/”.

4. A method according to claim 2, further comprising:
displaying, simultaneously with said first and second numerals, a plurality of icons which includes at least one icon representing the first user, at least one other icon representing the designated group, and at least one further icon to indicate the first user is transmitting or a member of the designated group is transmitting.

5. (canceled)

6. A method according to claim 2, wherein the group is designated by selecting an identifier of the group.

7. A method according to claim 2, wherein the group is designated by selecting a respective identifier for each member of the group.

8-18. (canceled)

19. A cellular telephone, comprising:
a processor;
communication means, operatively coupled to the processor, for receiving and transmitting information;
a display component operatively coupled to the processor; and
a memory operatively coupled to the processor and storing software adapted to control the processor to:
store in the memory a designation of a group of users of other cellular telephones;
place the cellular telephone in a mode in which a group call is supported among more than two parties according to a push-to-talk-over-cellular (PoC) procedure;
enter into a group call session in accordance with said PoC procedure, the designated group being selected for the group call session; and
display on the display component information that indicates how many members of the designated group are in an active status relative to the group call session;
wherein the display component displays a first numeral that indicates how many members of the designated group are in an active status relative to the group call session, followed in space on the display component by a symbol, followed in space on the display component by a second numeral that indicates how many members are included in the designated group.

20. A cellular telephone according to claim 19, wherein the symbol is “/”.

21. The cellular telephone according to claim 19, wherein the display component displays, simultaneously with said first and second numerals, a plurality of icons which includes at least one icon representing a user of the cellular telephone, at least one other icon representing the designated group, and at least one further icon to indicate the user of the cellular telephone is transmitting or a member of the designated group is transmitting.

22. (canceled)

23. A cellular telephone according to claim 19, wherein the group is designated by selecting an identifier of the group.

24. A cellular telephone according to claim 19, wherein the group is designated by selecting a respective identifier for each member of the group.

25-34. (canceled)
